(19) United States
(12) Patent Application Publication
(10) Pub. No.: US 2007/0130584 A1
(43) Pub. Date: Jun. 7, 2007

(54) Method and device for producing and sending a television program by means of ip-based media, especially the internet

(76) Inventor: Ingo Wolf, Pullach (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/556,176

(22) PCT Filed: May 10, 2004
(86) PCT No.: PCT/EP04/05000

§ 371 Date: Feb. 9, 2007

(30) Foreign Application Priority Data
May 9, 2003 (DE) 103 20 889.5

(51) Int. Cl. H04N 7/16; H04N 5/445

(52) U.S. Cl. 725/46; 725/135; 725/45

(57) ABSTRACT

A method and device to generate and transmit a television programme via IP-based media, particularly the Internet are provided. In particular, a method of transmitting transmission segments in time-controlled programme streams, particularly for TV segments, according to a fixed programme, via the Internet, for viewing by users, and a method of operating television stations are provided.

The invention concerns a method and device to generate and transmit a television programme via the Internet. In particular, the invention concerns a method of transmitting transmission segments, particularly for TV segments, according to a fixed programme, via the Internet, for viewing by users, a method of editing transmission segments consisting of individual film segments via the Internet, and a method of operating a television station.

### BACKGROUND

In the prior art, programmes with which programme loops can be set up are used in the Internet. Multiple segments are simply entered in a list and played back in sequence. Viewers can access them and view these programme loops. However, if a segment hangs during transmission, the transmission time of all subsequent segments changes. Also, because of the undefined transmission times, there is no possibility of setting up a programme notice.

Offering asf or wmf files on demand is also known. In this case, segments are called up on demand by the viewer and then downloaded. But if a segment is available on demand, it can also be recorded. It is thus possible to pass it on to third parties, which is often not wanted, because of licence rights in particular.

With a live encoder PC and a corresponding encoder card, anyone can encode a television or camera signal live in poor quality, and have it streamed via a point-to-point connection to a server. Here very many users can access the stream in parallel. However, if something does not function in the transmission or someone makes a mistake, it can no longer be processed. In this technique, the material is not usually stored, and there are only very few types of application, e.g. press conferences, general meetings, sport and news. If the number of viewers is 1,400 or more, on standard servers there are already problems with transmission. For DSL, the limit is even below 200 users. For normal television to many viewers, therefore, very expensive server systems with load balancing in the IP balancing method must be used. This technique is from the early period of the Internet, and is extremely unsuitable for IP television.

### SUMMARY OF THE INVENTION

An object of the present invention was therefore to provide a method and a device for generating and transmitting a television programme via IP-based media, particularly the Internet, while avoiding the disadvantages of the prior art.

This object is achieved by a method of transmitting a sequence of transmission segments (transmitters), particularly for TV segments, according to a fixed programme, from multiple transmission servers, via packet-oriented distribution paths such as, in particular, the Internet, for viewing by users, the transmission segment being transmitted on all transmission servers.

Transmission segments are film sequences, preferably with an audio track, which include individual segments, commentaries, news, recorded transmissions, advertising, reportage, feature films, etc. The transmission segments preferably exist in transmissible quality; the division into different line bandwidths for viewing by each Internet user is particularly preferred. The transmission segment can therefore be viewed, as required, both in higher qualities to improve the picture and in lower qualities, depending on storage and bandwidth.

Here, television means the transmission of moving pictures, which are displayed both two-dimensionally and three-dimensionally on the terminal for picture or video output. The number of pictures per second is constant as in the case of PAL and NTSC, or variable according to choice.

The transmission segments are preferably transmitted according to a fixed programme, i.e. in a predetermined sequence and at a specific time of day. The transmission programme which is predetermined in this way then includes start and end times of the various segments, defined by date and time. In this way a “true” or “running” programme is generated, as the viewer is accustomed to from television and as has been declared, including for licence contracts, since the early period of traditional television.

The programme is transmitted from multiple transmission servers. A transmission server is preferably a facility from which individual transmission segments can be transmitted, in succession and time-controlled, according to a defined programme plan. In an advantageous embodiment, the transmission server can also access the corresponding segments in digital form, and transmits them according to the programme plan of the fixed programme. Specially preferably, the transmission server includes a computer or control unit, which loads and plays back the individual transmission segments at the proper time. The transmission server thus preferably includes software to play back transmission segments, such as for example Microsoft Windows Media Player®.

The transmission segments are transmitted via packet-oriented distribution paths. These are, in particular, digital distribution paths such as, in particular, the Internet and/or IP-based media and/or DVB (Digital Video Broadcast) media. Via these distribution media, the transmission server, which is preferably equipped with the technology for conversion, programme production, programme planning and digital transmission of sound and picture, can generate a running or fixed programme. Separately, live sources, which are coded and transmitted directly, are known. In the method according to the invention, all video data are preferably stored on the transmission servers in advance and then transmitted via server networks according to time control. Preferably, in this way the inclusion of audio and video contents in websites and as autonomous TV transmitters, which function independently of the distribution medium, is provided. Audio and video elements can preferably be included in HTML pages and called up in parallel on demand. Packing IP streams, which are constructed from databases under time control, into DVB streams is specially preferred. The reverse route, i.e. generation of a time-controlled DVB stream and live coding into an IP stream, is also possible. The programme is thus preferably offered via the Internet, so that the viewer does not need a television set to see the programme, but a PC or a UMTS mobile telephone is enough. Preferably, the viewer selects a URL via which he or she can see the fixed programme or the transmission segments. The method makes possible, at a defined time, the simultaneous and interactive viewing and calling up of audio and video data in arbitrary transmission networks, without a file download being required.

Because the transmission segment is transmitted simultaneously on all transmission servers, an extremely autonomous and interference-free transmission system is provided by the decentralized and parallel server structure. Whereas traditional transmitters transmit at a single point, and from there follow different distribution paths, according to the method described here the same programme is generated simultaneously by multiple transmitters and transmitted in parallel from multiple sources. In this way, for the first time in packet-oriented distribution paths, it is possible to enable a large number of users or viewers to receive a fixed or running programme, without overloads occurring. Because all transmission servers can transmit the same segments according to the same programme sequence, a large public can now be reached via packet-oriented distribution paths. The common programme sequence is made available to the individual transmission servers for a specified future time. According to this programme sequence, the individual servers, independently of each other but on the basis of the time-controlled fixed programme, simultaneously transmit the defined programme according to the programme sequence. Then, at regular intervals, a running programme sequence which reaches still further into the future, and according to which the transmission servers can then continue to transmit independently of each other, can be made available to the transmission servers. In this way, even if one transmitter or transmission server fails, the transmission segment or fixed programme can still be received. Even if new transmission sequence plans are no longer made available, the transmitters would still be able to continue to transmit, according to the then existing transmission sequence plan, for months, or as long as the already received sequence plan reaches. In this way, an interference-free system which can reach a large public even via packet-oriented distribution paths is provided, without the necessity of providing extremely high bandwidths for a corresponding server.

In the case of another preferable embodiment of the present invention, the transmission segment is started only when the first viewer accesses the transmission segment or the transmitter. Specially preferably, the transmission segment is then also put onto the correct programme point when the first user has accessed the transmission segment of this transmission server. In this way, server resources for playing back are saved, since the programme does not have to run irrespective of whether anyone is watching or not. The transmission segment is not called up or loaded and made accessible until an access to the specific programme takes place. In this case the transmission segment is put onto the correct programme point depending on a transmission plan, i.e. the (first) viewer jumps to exactly that instant of the segment up to which the segment would now have run according to the transmission plan. If more viewers are interested in a segment, depending on the number of viewers the transmission capacity can be adjusted and provided individually. This happens preferably on multiple servers which are used in a decentralized way, and transmit in parallel and at low level. In this way, it is unnecessary to keep a high bandwidth constantly ready from only one transmission centre—the capacity is directly adapted to the demand, and thus resources are saved.

An advantage here is the access of a viewer to a programme stream which runs, but does not have to run, on the server. Access takes place at an arbitrary time into the middle of a segment. The viewer has the impression of having switched on as in the case of a normal TV station. In internal networks of companies, the IP stream of the running programme preferably runs without interruption, since in this way an individual stream does not have to be transmitted to each user, but only one stream, which everyone sees, can be transmitted, and thus the network load can be significantly reduced. In the Internet, the programme is only started and put onto the correct programme point in the middle of the segment when the first user accesses the transmission stream. The basis for playback is the generated transmission databases. The programme content can be on any servers in the transmission network. As well as live playback, this is also the only way to send a time-dependent programme by IP on satellites.

By this method, a transmission segment is offered in the IP transmission method, according to a fixed programme sequence, via the Internet or a satellite, without the possibility of postponements and time jumps, and in which also the load on the network is regulated, for multiple transmitters in parallel in a server network of arbitrary size, depending on the users who are actually viewing.

In another embodiment, the transmission segments of the fixed programme are held in parallel in a database, for use in the running programme. In this way, segments which have been missed can be seen subsequently on demand. After the transmission plan has reached a specified time, parts of the files can be automatically deleted from the programme, so that the whole programme does not have to be kept.

Additionally, with this solution it is possible to operate multiple running programmes, for different target groups, from a pool of videos, from one transmitter in parallel, without additional costs of a technical nature.

If a viewer wants to see the fixed programme at a particular time, only the current segment must be loaded and provided from the point which results from the current time of day. Segments, or parts of the current segment, which have already run no longer have to be loaded, and thus it is unnecessary to pay for any traffic for them. The costs for the transmission operator are thus minimized, including in relation to the distribution of TV segments.

The basic database contains, in simple table form, partly with decentralized sub-databases, all the information of the TV programme. The information which is included is licence data, originator data, length and type of segment, categorization, keywords for search routines, FSK [freiwillige Selbstkontrolle=voluntary self-control (of films)] data, cleared transmission servers, target group data, cleared distribution paths, security codes to avoid wrong accesses, transmission times for the running programme, data about inclusion in mixed segments, entry times for display of parallel tables and presentations, prices for pay TV applications, links to shops, data for transmission in the on-demand method, information about proficiency level queries for training videos.

By means of these data and a special way of storing data in FileLoadBalancing, it is possible to adapt the individual segments even better to the required capacities during transmission. In this way too, access times can be optimized and rights can be ensured.

In another preferable embodiment of the present invention, the sequence of transmission segments, or their starts of transmission on the transmission servers, differ on the basis of features of the user, particularly age, sex, time zone, education, consumer behaviour, empirical investigation of the user's programme use, interests, language.

In another preferable embodiment of the present invention, a transmission path depends on one of the following features: viewer's data line, viewer's IP domain, ping time to nearest server.

In this way, on the basis of a specific profile or feature of a user, it is possible to offer the user different transmission segments, while a different transmission segment is offered in parallel to other viewers. It is thus possible, instead of a segment which is provided in the running programme with a high FSK assessment, to play another, alternative segment in this time for users who have not yet reached a specific age. For instance, in Germany it is impossible to show FSK-18 films before 23:00, since it is assumed that children could still be watching. Now, if someone from another time zone accesses such a segment or transmitter, depending on the fact that for this viewer or user it is not yet 23:00, an alternative segment could be offered. In this way, it is possible to act on the relevant programme sequence very individually and in the very short term, and to change it appropriately. In the same way, it is possible to change the programme in the short term depending on external factors—for instance, a segment could be replaced because of a weather situation. In this way, it is possible to act on the programme planning in the short term, and for this to react individually depending on external factors (time zones, weather, etc.) or individual user profiles (IP domain, age, etc.).

Not only can control by the programme planning tool executed by an editor lead to a time-controlled sequence plan, but so can event control and logic control. For instance, the programme can insert a segment into the planning because the weather has changed and it is therefore necessary to transmit a different actual weather description, which has already been produced. A typical application example, in home order TV, is the case that a product has sold out, and a spokesperson video which gives information about this selling out is played.

Logical control can take place if, for instance, a segment was classified on the corresponding transmission server as damaged, or if the customer has not yet paid for a segment up to transmission. The transmission control of the software can autonomously cause a similar segment to be transmitted.

Other features of the user are preferably one or more of the following groups: IP domain, ping time, age, sex, time zone, education, consumer behaviour, empirical investigation of the user's programme use, interests, language, etc.

Preferably, transmission segments are distributed to decentralized servers and into different IP domains, which are controlled by editorial transmission databases or automatically in the neural network. The planning of file holding and file retention is then adapted to demand from the different IP domains. In this way, segments are only on hard disks of servers from which they are also requested. Also, segments are then multiply on servers of the FileLoadBalancing network, if there is a particularly high demand for them or if, on the basis of experience, the system has established empirically that for the future it would be useful to hold a particular segment multiply.

In an implementation variant with neural network programming, the method, by means of software, can delete parts of its own programming or add to its own algorithms from a supply server, if the corresponding functions are required. Thus not only management of the videos is carried out, but one which concerns itself directly with the main programme. The neural network also makes possible full utilization of hard disks and protection of them from overload. This is done by distribution of transmission videos to multiple servers. In another version of the application, the method also checks accesses to the system and warns of potential intruders into the programming.

The digitized audiovisual running programmes make special demands on the transmission speed of networks and powerful server networks of the providers. In the whole TV sector, information for distribution in IP networks and distribution in DVB networks is processed and stored digitally, which allows the FileLoadBalancing method for distribution of video data in the connected networks to appear advantageous.

The FileLoadBalancing system consists of an intelligent software tool, which learns autonomously via neural network programming where and when contents could be requested. It works preferably on a decentralized basis, to keep all databases small and fast. Preferably, it also handles licence administration and transmitter franchising. On the basis of constantly running analyses of transmission links, models of viewing habits are built up in the software. The relationships which have been set up are evaluated and processed demographically, in relation to content, according to cultural groups, languages and other factors. Assumptions about the future of the programme queries are now made. In this way, for the near future, assumptions which help to provide all TV segments on the correct playback servers in the correct IP domains are made. Evaluations of the more distant future are used to make suggestions to programme planners about programme structure or to adapt programmes fully automatically to the viewing habits of defined target groups. Data distribution functions on an arbitrary number of transmission servers in all important IP domains of the whole world. This ensures the best accessibility for all users irrespective of location. The system is constructed modularly, in such a way that any number of transmission servers can be connected or disconnected without affecting transmission operation. This makes it possible to replace whole servers easily, without expensive hot plug technology.

Using the distribution testing tool, the countries and regions from which viewers come are monitored via IP domain queries. For instance, the correct language versions can be transmitted to the appropriate countries. With this tool, contents can also be restricted and licensed regionally. Legal questions are more important in the Internet than with television stations because of the high distribution and good accessibility. With easy access and world-wide distribution, there is also the question of youth protection. The Internet TV service providers are only allowed to transmit transmissions with contents which are released by FSK, as in the case of cable TV. According to the German rules, transmissions which are released with FSK 16 can be transmitted in television only from 22:00, and transmissions which are released with FSK 18 only from 23:00, which does not agree with FSF [Freiwillige Selbstkontrolle Fernsehen=voluntary self-control television] rules in other countries. In the Internet, following such transmissions is difficult to check, e.g. in the case of Video On Demand, or because of international time differences. For this reason, it is only possible to work here with running programmes which function with time zone control.

In another embodiment of the present invention, transmission segments are distributed on decentralized servers, controlled by sub-databases, by an expert system and/or a self-learning network. These systems can learn, depending on individual parameters, from past viewing habits and other parameters. The loading can thus be regulated depending on viewing habits, access times, origin of the query, network loading, viewer structure, etc. Preferably, the data are also used in a particular tool, which gives suggestions for programme planning to the editors, or does the programme planning itself and constantly optimizes it on the basis of experience.

Preferably, programme contents are held as a file on a base server and then distributed via a self-learning network on various servers in various IP domains. The neural network learns in a decentralized way, and compares viewing habits with access times and origin of the query. On the basis of the data, the network builds up a programme structure which the viewer might like in future. It learns connections and extends its knowledge about the viewer structure. With time, the network, of its own accord, becomes as intelligent as required, and supports or replaces the programme planners. There are currently only programs which evaluate queries about the user for normal Internet pages, and then put the pages further into the foreground of the Internet presence. These systems are not intelligent, and they do not move data to other servers in the network according to load criteria or viewing habits.

In another preferred method of the present invention, on one transmission server multiple different sequences of transmission segments (transmitters) are transmitted in parallel. It is thus possible, via one transmission server, to transmit not just one transmitter or channel, but multiple programmes simultaneously. In this way, the computing power of the individual server can be exploited better.

In a preferred method, the individual transmission segments of the multiple different sequences of transmission segments are held in databases which are separated from each other (multistation).

For instance, on one transmission server there are then preferably multiple databases, with a corresponding programme sequence and also the files for the programme content. These databases then represent a single transmitter, which can be transmitted in parallel on the transmission server. The individual databases are not in contact with each other. In this way, it is possible to provide multiple transmitters for different customers on one transmission server, without the customers being able to access the data of other customers.

In another embodiment of the present invention, the individual transmission segments of the multiple different sequences of transmission segments are held in one database (multichannel). In this way, it is possible to offer different transmitters via one transmission server, but they are fed from one and the same database. In this way, individual transmission segments can be held once in this database and do not have to be stored multiply in the different databases, once per database. In this way, the storage requirement is reduced, even in the case of multiple transmitters via one transmission server.

In the case of another preferred method of the present invention, the same sequence of transmission segments is transmitted in parallel in different bandwidths. In this way, it is possible that one or more transmission servers transmit the same segment, regarding content, in parallel at the same time, but in different transmission qualities or transmission bandwidths. It is thus possible that a high-resolution segment for large transmission bandwidths is offered in parallel to an economical version for small bandwidths. In the prior art, this was not possible until now, since in this case the procedure always had to be cascading; the high-quality transmission segment was transmitted live, and the signal was then used to create a lower version. This was produced with a time delay, and could then also be transmitted about one minute later, from which again a corresponding qualitatively reduced version was created, and could again be transmitted with corresponding time delay. Thus multiple computers were required to generate the different qualities. The qualities could also be generated in parallel, if the signal source of the live signal was split and live encoded on multiple computers. In the prior art, there is also a technically imperfect method of packing multiple transmission qualities in one stream, which above all generates the mixture ratio of audio and video data only extremely unfavourably, since only one audio bandwidth is available for each video signal. Thus the audio signal at high bandwidth is too bad, and at low bandwidth is too good, and also affects the video picture at low bandwidths negatively. As shown in this invention, it is now possible to offer all transmission segments simultaneously in the different transmission qualities, since the transmission segments already exist, completely encoded in different qualities, and can be transmitted in parallel from a single transmission server. This is advantageous, since the transmission quality of video and audio under ISDN has improved in the meantime, but television standard is only achieved with the broadband techniques, DSL and subsequent. Internet TV service providers must provide various formats and bandwidths, to make the optimum quality available to different user groups (e.g. modem, ISDN, LAN, SAT, UMTS, WLAN). For this reason, it is very advantageous that multiple transmission streams with the same content can be controlled in different qualities from one database. Preferably, interfaces for software which controls and monitors the transmission sequence even of traditional TV stations are used.

Particularly preferably, in one method of the present invention the sequence of transmission segments is automatically fixed on the basis of the user's profile data. In this way, it is possible to offer a programme which meets the user's inclinations and viewing habits automatically to the corresponding user. On the one hand, one way in which this can happen is that a special programme is assigned to the corresponding user profile of many viewers, and the viewer is thus assigned to this user profile on the basis of selected criteria. However, in the extreme case the result can be that an extremely individual programme is put together for the individual user. Specially preferably, for instance, the user is then also informed in advance about a programme magazine, from which he or she can take the programme which has been individually automatically put together for him or her for the next few weeks. By feedback of the segments which are then actually watched, in future the programme can be tailored even more optimally to the corresponding requirement profiles of the individual user.

It is also possible that the individual transmission segments are put together by a user himself or herself, and the user then offers these transmissions to a previously selected group. It would thus be possible, for instance, for a teacher, in parallel with the material which he or she teaches in the school, to offer an accompanying programme with transmission segments to his or her pupils, who can watch it in the afternoon, to obtain further background information about the subjects which are dealt with, or similar subjects. In this way, the teacher will be able to offer his or her pupils a television programme which the teacher has put together himself or herself, to accompany the teaching.

An object is also achieved by a device and a method for transmitting a programme via multiple distribution paths and for multiple customers simultaneously. In transmitter franchising, a running programme is transmitted simultaneously in multiple transmitters, each of which is adapted to the corporate design of the franchisee. Thus programme planning can serve multiple customers simultaneously. The method and the device also make it possible to construct, from one database, the programme planning for multiple customers, differently but from the same base transmitter (video data stock). Preferably, the device simultaneously handles the licensing of video segments and the payment for the licences by the franchisee.

An object is also achieved by a method of operating a television station via packet-oriented distribution paths, including the steps of access to a television network, access to a central or optionally decentralized database, on which transmission segments are managed depending on, in particular, the viewing habits of the transmitter target group and the loading of the transmission servers of individual IP-based TV stations; optional creation of segments, which occur as a new file, and as a new segment automatically influence the licensing; optionally finding further segments and implemented film clips and inclusion in the segment by automatic editing or insertion into the transmission sequence without generating a new segment; transmission of these transmission segments depending on accesses by viewers.

By using these components, a television transmitter can access, in a decentralized way, individual segments, which are preferably put together by an expert system or neural network in a transmission plan, depending on the listed parameters of the viewers' viewing habits. In this way, not only the management of the individual segments, but even the editing of segments and the composition of the programme, are automated on the basis of a transmission plan which is optimized by the system, and thus an individually optimized programme for viewer groups is defined and provided.

Preferably, it is also provided that anyone can provide transmission segments on the decentralized database as raw cut material or finished segment. In this way, any third party is enabled to provide segments, which the system can (automatically) access and also build them into transmission plans and license them. Thus an interactive network, in which every user can be viewer and transmitter simultaneously, is provided. The system can work in all IP domains, but becomes particularly interesting, particularly in broadcast networks such as UMTS or wireless LAN.

In this way, a method by which the television set is not merely operated as “one-to-many TV” as until now, but can be in the form of “many-to-many TV”, is provided. Because everyone is able, using the appropriate editing programme, to define a programme sequence which is then transmitted via a transmission server, extremely individual television segments can be created for narrow groups of persons. For instance, it is possible that the grandson sets up a television channel for his granny, and as well as her favourite films the latest holiday film clips run repeatedly in it. Companies can provide specific contents for their customers or sales employees via a television channel, to which they supply special programmes via the editing program, in combination with the running plans of the servers. Technologically, this editing program (TV-Edit) can be used from any terminal, and thus incorporate a server into FileLoadBalancing. This transmission server can be a traditional PC, a notebook with mobile reception, a UMTS mobile telephone, etc. Thus every user can become his or her own transmitter, and put together his or her own or externally licensed TV material into a programme, license it on via license providers for third parties, or buy whole programmes and distribute them via the user's own PC as TV programmes.

Preferably, transmitters which are generated by means of the method can also be put onto storage media such as CDs or DVDs, and played back from there. In this way, it is also possible to feed television into networks which function independently of the Internet or other networks and have no satellite link of their own. This programme can then be seen on standalone terminals. It is thus also possible to offer TV for individual companies internally or for specific customer groups.

The user can choose to be viewer or transmitter. Functioning as transmitter, the user's computer can function as transmission server, or the user uses FileLoadBalancing, and uses its server as a greater transmission platform.

Thus television on demand and in the running programme can be transmitted and received by all distribution media which can be used via IP or DVB, and every transmitter operator can be seen by every surfer in the IP space. Behind the operator software which makes it possible to construct a modular television transmitter, there is a decentralized database which is connected to the neural FileLoadBalancing and to the television server network. The user can also include all contents which he or she wants to show in the licensing network. At this moment, his or her contents are also available to all other transmitter operators. The operators can buy licences and then include the contents in their own transmitters. Thus anyone who operates a computer, a UMTS mobile telephone or any other IP-based device can make television for anyone else, subject to conforming to the legal provisions, e.g. on the subjects of youth protection and protection of the constitution.

In the prior art, there were not yet any modular systems for constructing television stations. Additionally, the networking of the programme contents between all transmitter operators is new. Now both the terminals and optionally the transmission servers in the Internet can function as transmitters. Here the user has the choice and even the possibility of free time combinations. The result is that a giant TV network which is completely independent of TV structures which are known today is possible. It will not be subject to any transmission restrictions, and will make access possible everywhere. It can be suspected that traditional television will be superseded in the next twenty years by the IP transmission path and transmission protocol.

An object is also achieved by a device to execute a method and/or a computer-readable program to execute one of the methods.

The editing method which is provided in this way can preferably be implemented as software (below: TV-Edit) for distribution of moving image contents taking account of geographical distribution, age restrictions, target group TV, connection quality, performance protection rights, copyright, pay TV, home order TV, extreme fail safety, automatic programme planning, automatic target group evaluation, upgrade risk minimization, etc.

The software preferably begins its work from the digitized video segment. The video exists at this moment as, for instance, avi or mpeg2. However, the role of the input formats is secondary. All relevant information about the video is then entered. This preferably includes additional pictures, links and shop links.

After all data are entered, the video files are converted into transmissible segments for IP-TV. This is done by a batch renderer, which contains the latest codecs. The segments are then saved and stored in parallel on the transmission servers by an intelligent distribution method.

Programme planning is also carried out in TV-Edit. There are three “transmission methods”:

Download TV: here the segments are managed in a content structure and released for download.

Personal TV: here segments can be selected via five different search methods or directly, and viewed by a mouse click at the moment of the request.

Running programme: here the segments are held in a programme sequence plan, similar to a programme magazine, and transmitted at specified times. This is a virtual reversal of the pull method. The methods all transmit in the modem, ISDN, DSL, SDSL, TV-DSL and UMTS transmission qualities. Thus the viewer with a good link always has full picture television of outstanding quality.

For true TV application via IP or DVB, with the possibility of transmitting to relatively large groups of subscribers in acceptable quality, a decentralized server phalanx in various IP domains with transmission capacities of several Gbit/sec is required. To be able to display moving images in different bandwidths, for data reduction an encoder system, which automatically computes prepared segments from an editing system or archive systems in different bandwidths and codecs, and then plays them back in defined transmission streams under time control, is required. By using the function according to the invention of running or fixed programmes, data can be converted to transmissible qualities by software and inexpensively. Usually, for different video material different settings for data reduction are also required. Preferably, batch renderers which make it possible to have many video files encoded via one network on converter computers in parallel are used. Preferably, the method is equipped with a backup mechanism, which backs up to hard disks, which are copied in redundant pairs at fixed intervals. On the transmission servers under FileLoadBalancing too, the segments are automatically multiply backed up by the device according to the preset in the backup setting.

Preferably, owners of rights to transmissions and segments can determine individual contents to the second, and evaluate the transmission of them in running programmes selectively. Using the provided method, programme notices and playout information for individual TV and radio transmitters are created. These programme notices and playout information are responsible for the investigation of which advertising spots and transmissions on which transmitters were actually transmitted, and in what environment. These tools provide the possibilities for investigation, transmission monitoring, evaluation (“quota”), observing the competition and protecting rights in IP-based and DVB-based running programmes.

### BRIEF DESCRIPTION OF THE DRAWINGS

The invention will now be explained in more detail on the basis of figures. The following is shown in the figures:

FIG. 1 a schematic view of the method of the present invention;

FIG. 2 another schematic view of an embodiment of the present invention;

FIGS. 3a to 3c schematic views of three embodiments of the present invention;

FIG. 4 a schematic flowchart for transmission and licensing according to an embodiment of the present invention;

FIG. 5 a schematic view of a hybrid TV channel according to an embodiment of the present invention;

FIG. 6 a schematic representation of the TV-Serve local according to another embodiment of the present invention, and

FIG. 7 a schematic flowchart to represent 1 network-TV.com according to an embodiment of the present invention.

### DETAILED DESCRIPTION

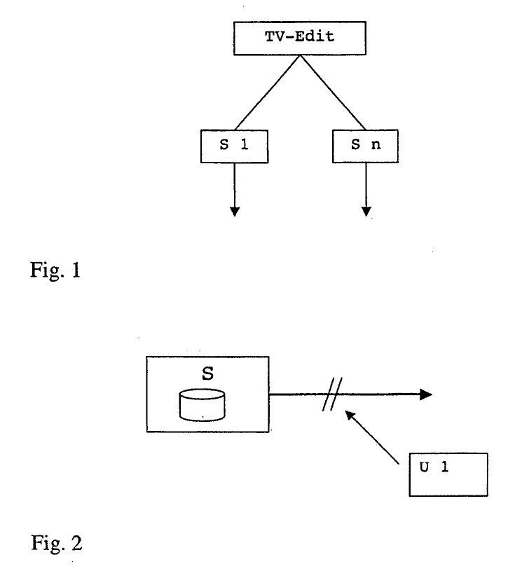

In FIG. 1, the method of the present invention is shown schematically. Via a TV-Edit module, various transmitter servers S1 to Sn are supplied with a programme sequence plan. The individual servers S1 to Sn then transmit a programme in parallel (shown by the arrows). In a first step, a programme plan is created using the TV-Edit module. This programme plan includes the start times and contents of the individual transmission segments which are to be transmitted. TV-Edit then makes the programme plan available to the individual servers S1 to Sn—in FIG. 1, two transmission servers are shown. The individual transmission servers now begin, in a decentralized way and independently of each other, to produce or transmit the corresponding programme according to the flowchart. In this way, the individual servers, independently of each other, can offer the corresponding programme in the packet-oriented distribution paths, without the programme having to be interrupted if the transmission server fails. In this case, that the transmitter S1 fails, the programme would be immediately offered on other transmitters, from which it could be called up. Changes or further developments of the programme sequence are then defined and passed to the individual transmission servers via the TV-Edit module, so that the individual servers can then all generate and transmit this programme in a decentralized way.

TV-Edit is preferably programme planning software with which an Internet television transmitter can be completely administered and formed. With this software, transmitter user interfaces are constructed, video archives are managed and all contents are put together offline in a transmission programme, exactly to the second. TV-Edit makes it possible to complete segments with text, Internet pages, pictures, links and shop links. With TV-Edit, videos can be rendered to different qualities in the stock converter, to enable each user group of the transmitter to receive with different network accesses from modem to TV-DSL or other bandwidths. Controlled by the database, TV-Edit manages the information about all files and segments which are ready for the programme and transmits them to the online transmission software TV-Serve on the transmission server S. TV-Serve constructs the running programmes according to the transmission planning, and transmits the contents, for instance using Windows Media Server (R) or another decoder, to the viewers.

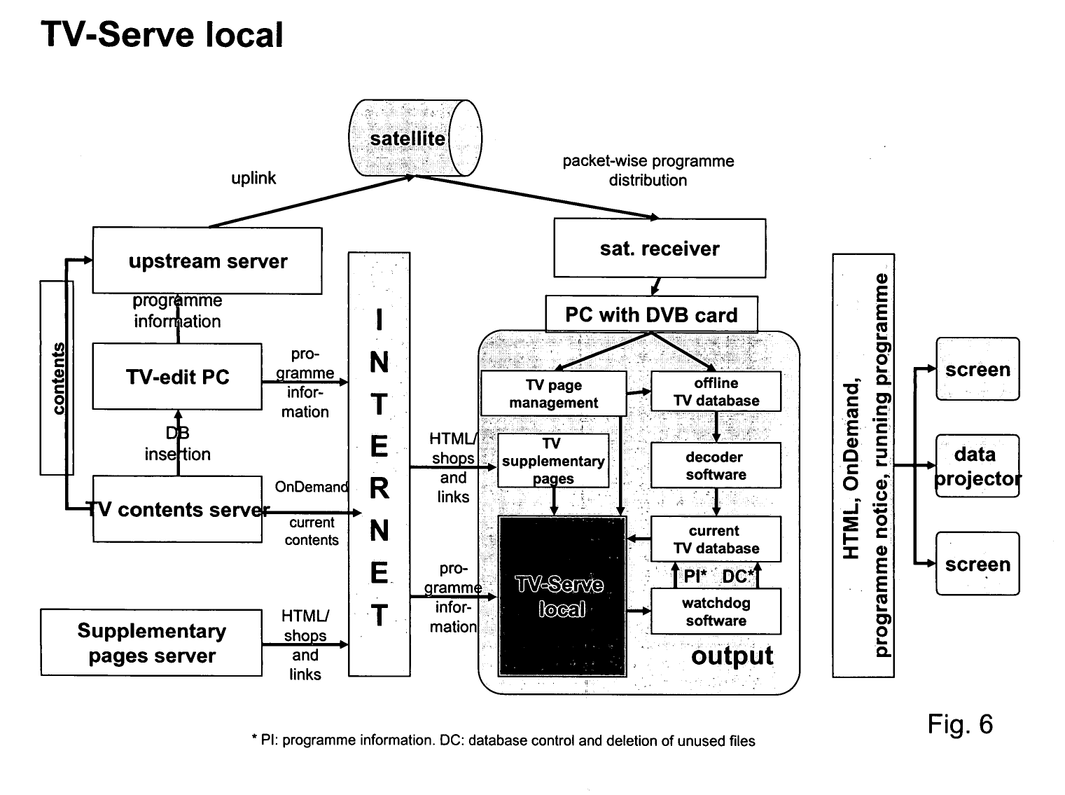

Provision on different servers in multiple networks is done by FileLoadBalancing. In this way, additionally, it is possible to transmit in the Internet in the on-demand or download method from the same server or multiple servers. The streaming applications are monitored by watchdog software (cf. FIG. 6 below).

First the video is imported into the system as MPEG2, avi or any other input format with its own ID number, name, headline, links, accompanying text, all originator data and keywords for using the search options, so that if required the segments on a particular subject can be quickly found. In a “Settings” window, the origin database, country, language, genre and FSK and other specific attributes are set.

In the video loading process, a video is rendered or encoded in multiple qualities, e.g. for ISDN (approx. 50 kbit/s), DSL (approx. 300 kbit/s), SDSL (approx. 1 Mbit/s) and TV-DSL (approx. 3 Mbit/s). Here the resolution and bandwidth and other parameters can be specified.

In a “Running programme” window, the transmissions from the existing videos are put together offline as transmission planning. The segments can be arranged in the “Video groups” window into a group, defined by specified criteria, e.g. subjects, countries or languages, and then inserted into the running programme. Videos can be brought together in the transmission programme both automatically with 12 different “Fill time ranges” commands and manually. With these commands, a time interval which is filled automatically according to logical criteria is specified. For instance, an English programme can be separated from a German one, or a programme for children from one for adults. It is even possible to fill whole days by this method, or to load previously prepared transmission schemes into new transmission days. It is also possible to fill with programme groups, i.e. prepared segments which are linked to each other. In the programme notice, only the name of the group is output, and all videos run in the programmed sequence under the one name. If contents in particular time windows are not set manually but set automatically according to logical criteria, this is called a “transmission”. A “transmission” in the running programme also has a fixed name, which is displayed in the programme notice. Regularly broadcast “transmissions” are inserted in the calendar with date and transmission time. If gaps occur during the programme planning processes, they can be filled automatically with suitable video material. In this way, advertising spots are inserted and monitored in the transmission planning. Using the TV data transfer tool, all information of the programme planning which was created offline is imported into transmission servers by FTP. The software automatically manages the reconciliation with the existing data, and loads new video files or deletes those which are no longer included in the plan.

In FIG. 2, a transmission server S, which can transmit a programme, is shown. A user U1 accesses the server to receive these transmission segments. In this embodiment, on the individual server S is the programme sequence plan, which it has received—as explained above in FIG. 1—by transmission from the TV-Edit module. However, the server S does not transmit this segment at first, but waits until the first user U1 actually accesses the segment. The programme is started and set to the correct time only at the instant at which the first user U1 requests this transmission segment, and the corresponding stream is only transmitted then. In this way, it is possible to keep the loading of the individual servers and the production and transmission of the stream low, depending on the requests. For instance, if 100 transmission servers are provided in a specific area, depending on the number of requests individual servers can be connected “slice by slice”, to provide further capacity. Until the first access by a user to this specific transmission server S, no stream would be generated and transmitted, which saves transmitter resources.

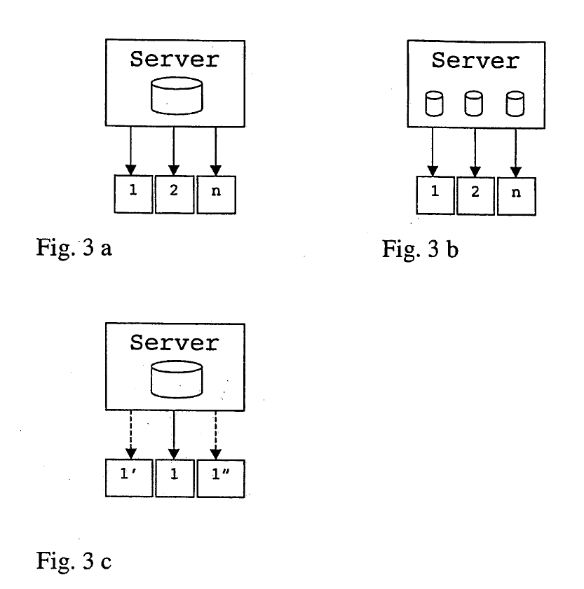

In FIG. 3a, a transmission server S, which transmits programmes or transmitters 1, 2 and n, is shown. Within the server S, a database, which contains all the files which the corresponding programme sequence plan of the individual transmitters 1 to n requires in the near future, is provided. In this way, it is possible that the transmitters use the same resource, and files can be made available in an optimized way.

In FIG. 3b, another version, in which the server S from FIG. 3a holds a specific, self-contained database for each of the transmitters 1 to n, is shown. In this way, it is possible to take account of the corresponding security requirements of the users of the individual transmitters. This is particularly important if the individual transmitters are offered by different persons.

In FIG. 3c, an embodiment in which a server S broadcasts a transmitter 1, and in parallel to it offers a transmitter 1′ and 1″, is shown. On these transmitters 1′ and 1″, in parallel with the actual transmitter 1, the same contents can be offered simultaneously in a different distribution quality, or depending on the user or viewer, other contents can be displayed briefly. It is thus conceivable that in the case of transmission of news, a user has stated in his or her profile that he or she does not want to see any bloodthirsty pictures in the news. In this case, as well as the reporting which takes place on transmitter 1 with appropriate picture material, via transmitter 1″ an alternative picture would be shown, and the user with the appropriate profile then receives and sees it briefly in parallel.

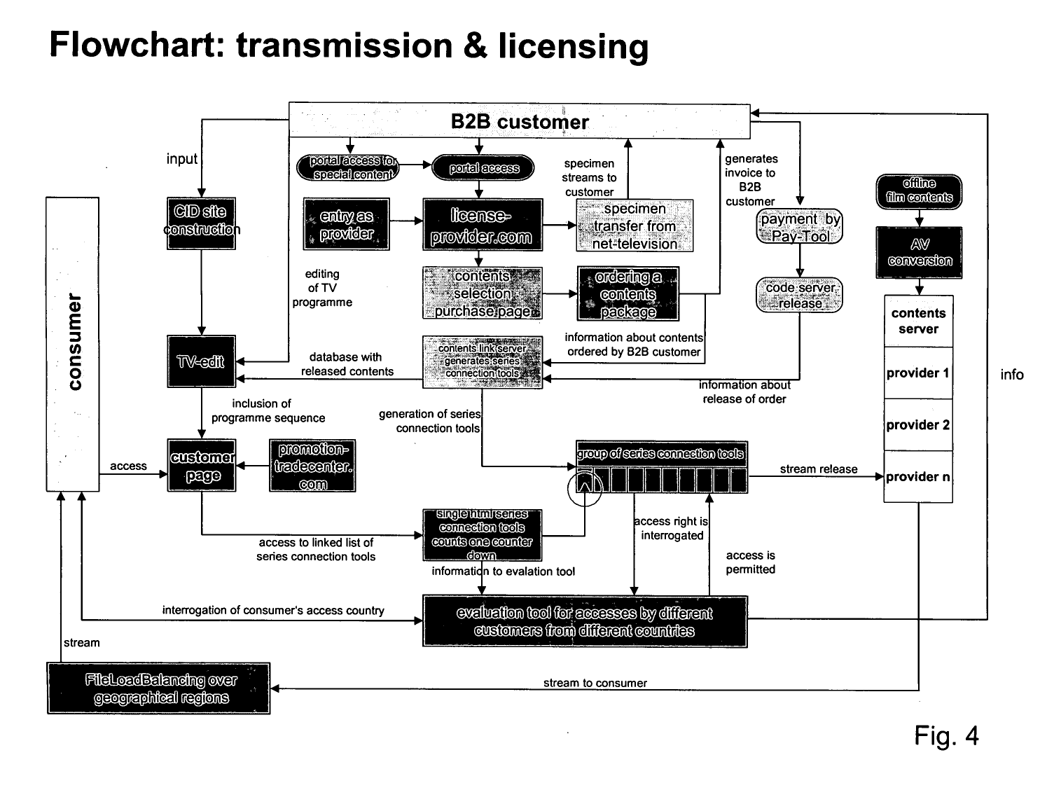

In FIG. 4, the flowchart for transmission and licensing according to an embodiment of a method according to the invention is shown schematically.

The description assumes a B2B customer. This is, for instance, a franchisee or customer, which operates transmitters and wants to buy external contents for its own transmission operation. This customer is the actual franchisee or transmission operator, on which the business model of leasing and communicating contents depends commercially. It receives the simplest access to TV segments and the possibility of immediate distribution of the segments on its own transmitter.

The B2B customer receives a tool for constructing the Internet page to the transmitter. The tool is here called CID (Corporate Internet Designer). This is a tool to generate an Internet page, and contains elements for linking IP-TV stations. The tool has rights levels for changing layout components of a TV page. The B2B customer can use the tool simply to construct an Internet page around the IP-TV transmitter. The generated pages automatically include the link to the television distribution technology.

The B2B customer also receives a portal access for special contents. This is a search machine for special contents, which already belong to a particular television transmitter and are to be licensed on for a second television transmitter. The search machine is used to find contents quickly, so that the customer can find and then order a segment which suits its TV programme by means of the five offered search methods.

Additionally, a portal access, via which an input identifier for use by licence provider in the B2B field is implemented, is provided. The purpose of the input identifier is to construct a restricted user group. The closed user group is intended to protect actual television providers from uninvited guests from the range of end users. Logging in is a pure formality. However, in this embodiment, the user must have use permission for IP-based TV stations.

Via the “Entry as provider” module, every operator of an IP-TV transmitter can offer its contents to other operators of IP-TV transmitters for lease, without the contents physically leaving the hard disks on which they are stored. The purpose of this is data security and the avoidance of theft. In this way, every content producer which operates at least one specimen transmitter with its material is also enabled to sell the second use rights.

The central platform for licensing TV segments is represented by the License-Provider.com module. On the core licensing part, payment, use and provision are organized and electronically handled. The URL can be replaced and converted into a client-capable version. In this way, different content platforms with different alignments of the material can occur. The platform can be used to function in communities.

Via the “Specimen transmitter from net-television” module, any content provider which also operates these data on a transmitter can show its contents to the licensee in context, included in a whole transmitter. The specimen transmitter ensures that only contents about which the provider can prove that the rights belong to it and that it actually uses them to broadcast are shown. The platform is a psychological protection against providers which have stolen contents to provide and sell them. Because on its own transmitter, the provider makes public by its imprint that it owns and is liable for the contents.

In the “Contents selection purchase page” module, videos which are free for licensing can be selected and put into a kind of basket. The user gets the opportunity to collect the desired contents and then to decide which of them it wants to transmit. Here it can also have the licensing prices summed. Preferably, it is only possible to use contents for a specified time. The retrieval numbers for this are inconsiderable at first, but are paid to the technical service provider via the resulting traffic.

The B2B customer now puts contents together in the “Ordering a content package” module. The selected contents can then be ordered electronically. When the user of the platform has decided on specified contents, it can order electronically, and receives an invoice which is automatically generated as mail. Simultaneously, electronic information goes to the contents link server, which stores the order and waits for the release after the payment has been made.

Via the “Pay-Tool” module, a tool to handle payment processes for TV licences is provided. Pay-Tool finds out, via information from the bank which receives the amount, the amount of the payment which the customer has made. The tool compares the payment and order and passes on corresponding information to the code server.

The “Code server release” module is used for verification. A special server called the code server assigns a unique code for the payment made and the associated performance. The code is passed on to the contents link server after the payment amount is checked for correctness.

The contents link server is used to store information about the relationship between particular contents and a defined customer. On the contents link server, the information about the customer's order goes in, and after the payment a code, which confirms the payment of exactly one specified content package. This information is decrypted by the contents link server. Then, for each relationship between a particular content and a defined customer, a series connection tool is generated on it, and contains all necessary information for transmission and its restriction. In parallel, the contents link server generates a data set, which can be read by TV-Edit, the programme formation software. The data set contains metadata about the videos, and text, pictures and attributions of the contents.

Now, to define the fixed programme, the “TV-Edit” tool is used. This is a programme formation tool to generate on-demand and running programmes. Here contents are prepared for transmission in an IP-TV transmitter, and grouped for transmission, and written into programme notices. TV-Edit edits both the customer's own videos and purchased databases, which follow in form the same data set structures as the original programme data of a customer's own material. Programme planning can be carried out on contents which are not on the programme planning computer. This is done only on the basis of the database which is generated on the contents link server after purchase by a licence user. TV-Edit then generates the programme notices and passes on the programme planning file to the contents transmission servers.

The “Group of series connection tools” module includes small databases, which are each only valid in the relationship between a customer and a single defined transmission segment. The series connection tools contain the information about the purchase price, the frequency of the permitted use, the IP domains or geographical spaces which are permitted for use, information about the restriction of use in a defined customer transmitter, the number of previously called streams, statistical data about the type of use in running programmes or on demand, and information about the type of content and its permitted transmission bandwidths. The series connection tools are originally used, in the case of a query by a consumer, for the purpose of granting or refusing permission to transmit. The information listed above is used for this purpose. The series connection tool releases the contents on the provider server after the logical release by the software of the contents link server. The series connection tool takes the information about the storage location of the original video data from the video management of the FileLoadBalancing process.

The “Customer site” module represents the customer's provider page, behind which the IP-TV transmitter is operated in the Internet. The page usually contains, as well as information about the transmission streams of the Internet transmitter, the access data for IP-TV transmitters which are operated in parallel with satellite as the distribution path. The customer page is virtually the URL to find the transmitter in IP space. When a TV transmitter is called up, the customer page is the first contact with the customer and the medium for the consumer. It explains the use and contents of the transmitter for the user. It also contains Pay-TV applications for the case of subscription purchases which are not sold in relation to individual content. Pay-TV for individual streams is handled in the contents link server.

The “Promotiontradecenter.com” module is a platform for booking advertising via multiple IP-TV transmitters or individual booking of defined advertising on defined transmitters. The platform makes possible advertising space available and makes direct booking by customers possible.

The actual customer of the B2B customer is the “consumer”. In the broadest sense, this can be understood as the viewer of an IP-TV station. The consumer who can access the providers' TV transmitters from different countries is assigned to an IP domain, to establish whether or not sending a segment to the consumer is allowed.

Connected after it is the “Evaluation tool for accesses by different customers from different countries”. This should be seen as a tool to determine a geographical space in relation to an IP domain. The tool interrogates the consumer access and checks, on the basis of the series connection tool for the active transmitter, whether the access by the consumer can be permitted or not.

Then, in the “Individual html series connection tool” module, a small database from the group of series connection tools is integrated. The tool is activated when a consumer accesses a transmitter. It counts the customer access and enters it in the statistics. It receives the feedback from the transmitter saying on which server FileLoadBalancing has stored files of the desired contents and via which IP path the broadcast to the consumer should best take place. After release by the evaluation tool, it outputs information to the B2B customer that its contents have been seen once by a defined consumer at a defined time.

In the “Offline film contents” module, contents which are supplied on tape are combined. These contents must first be converted so that they can be transmitted on IP-based TV transmitters.

Then, with the “AV conversion” module, a process to prepare videos for transmission into the IP-based space is provided. All data are digitized and prepared for transmission in specified codecs. In general, it will be MPEG2 or asf data.

The “Contents server” is an Internet server for storing TV data and for direct on-demand streaming. For each transmitter, there is a transmission server, on which the data of a transmitter are stored in full or in clusters. A transmission network is built up via various provider servers. By connecting FileLoadBalancing, this transmission network becomes intelligent, and takes care of loading of servers and data security.

With the “FileLoadBalancing” module, a system for logical management of server space and streaming applications is provided. FileLoadBalancing reduces the disk load on transmission servers, and sorts contents onto different servers in multiple storage, to ensure that contents cannot be lost when a server crashes and that in the case of too high load enough servers distribute the same transmitters to ensure good reception by the consumer. Additionally, FileLoadBalancing provides feedback to the programme planning, to generate, from the viewer behaviour of the past, future programmes which the viewer will accept better. The tool is programmed to be self-constructing.

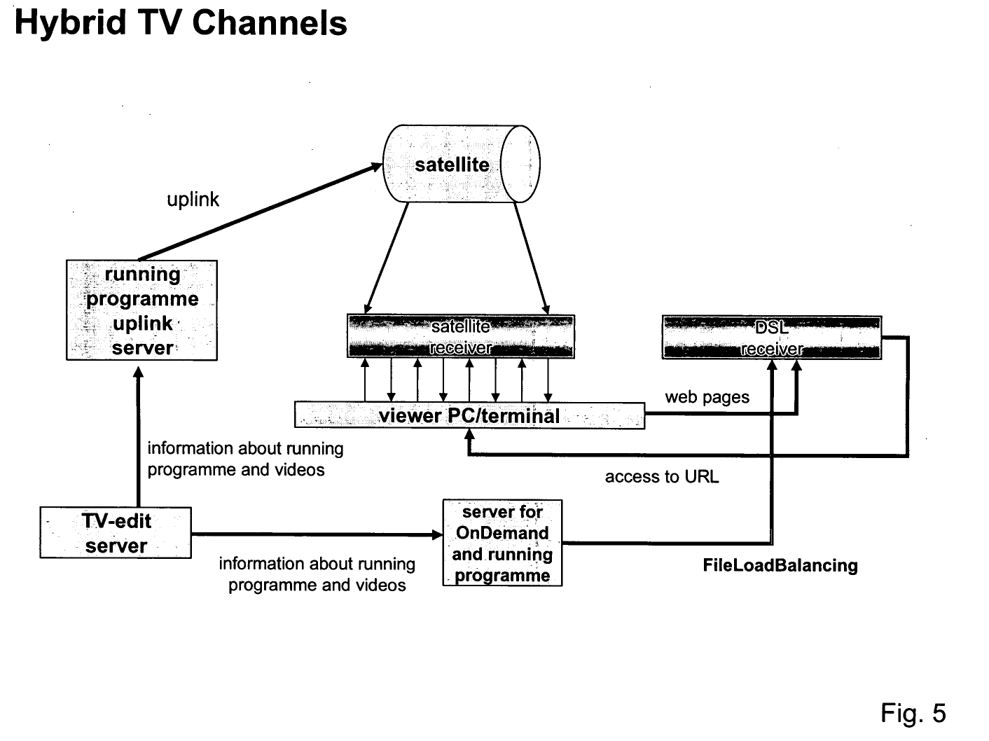

In FIG. 5, a schematic structure of the “Hybrid TV Channel” according to another embodiment of the present invention is shown. Transmitters which simultaneously control both an IP programme and a satellite or UMTS programme are called hybrid transmitters. In this form of the application, the transmitters are populated with the contents independently, but the transmission takes place from databases and simultaneously. For the viewer, the result is the impression of a single programme source and parallel broadcasting in different networks. In the case of the “local serve” form of the application (see FIG. 6 below), in which a computer must show programmes without a permanent network link, the same path is chosen. For POS television in company networks, the programme data and the programme notices are imported offline and then displayed simultaneously with the running programmes which are transmitted in the network, as if only one programme source was involved, as in a hybrid transmitter.

The “TV-Edit-Server” module (see FIG. 4) is a data server for Internet streaming which must run in parallel on satellites and via the Internet. From the process of FileLoadBalancing, as well as the distribution into the IP network of the Internet, a separate offline data stream is pushed onto the running programme uplink server. The data consist of both the programme planning and the segments in satellite transmission quality themselves.

The “running programme uplink server” is a storage and transmission server for satellite programmes. The server contains the next few hours of the video material to be transmitted for the satellite transmission stream, or optionally the transmission stream in a cable network or a UMTS network. Independently of FileLoadBalancing, an individual stream, which is influenced by the TV-Edit programme planning in transmission control, is generated. This ensures that the two programmes in the network and via the satellite are transmitted simultaneously.

The “satellite” is a transmission facility in space for passing on IP streams in the one-to-many method. For the purposes of the invention, “satellite” should be understood as representing the satellite, cable network or UMTS forms of distribution.

In the “Server for on-demand and running programme” module, a transmission server for IP television is provided. Here it represents the FileLoadBalancing transmission process in different IP-based networks. It is also possible to control even more uplink servers via the system, and thus to make worldwide synchronous TV possible.

The “DSL receiver” is a receiver unit of the customer for IP-based data. The receiver is representative of every IP-based or packet-based reception of Internet or television data. It passes on the Internet data of an upstream channel or of an original IP-TV channel to the viewer PC or its TV set.

The “viewer PC/terminal” is the consumer's reception hardware or software, and is representative of every kind of display of an Internet page and display of a stream, which is received from the IP-based Internet or from a satellite according to choice.

The “satellite receiver” is a reception unit, for instance a PC with DVB card. It is representative of every kind of reception facility for IP-based or packet-based streams which are distributed via satellite, cable network, stream network or UMTS.

Using this arrangement, it is possible to distribute a transmitter via the Internet and in parallel via a satellite.

In FIG. 6, a schematic representation of a “TV-Serve local” embodiment is shown. The process follows essentially the same mechanism as is carried out by a hybrid transmitter (FIG. 5). The difference is that instead of one uplink server, many individual PCs with the same information are responsible for transmission. Alternatively, the standalone devices, which can also be synchronized with another transmission stream, can be populated via a satellite or the Internet or offline by CD, DVD or via any other distribution medium.

The incoming data are intended for building pages of the TV transmitter graphic, for page management, for filling the transmission segments with current videos, for passing on the programme planning file to the local transmission system and for checking the function of the watchdog. Also, via the supplementary pages server, information which can be called up in parallel to the film segment is provided.

The watchdog fulfils the task of giving feedback if the system does not run without faults. The consequence of the feedback is a check on all processes, and can also be a restart of the system and a new entry into the transmission scheme.

The TV programme can be output from the standalone application on screens, data projectors or traditional screens, in 2 or 3 dimensions.

The system is capable, in addition to the transmission database, of collecting new data, and data which are only intended for one programme place, and transmitting it at previously defined times from the local database.

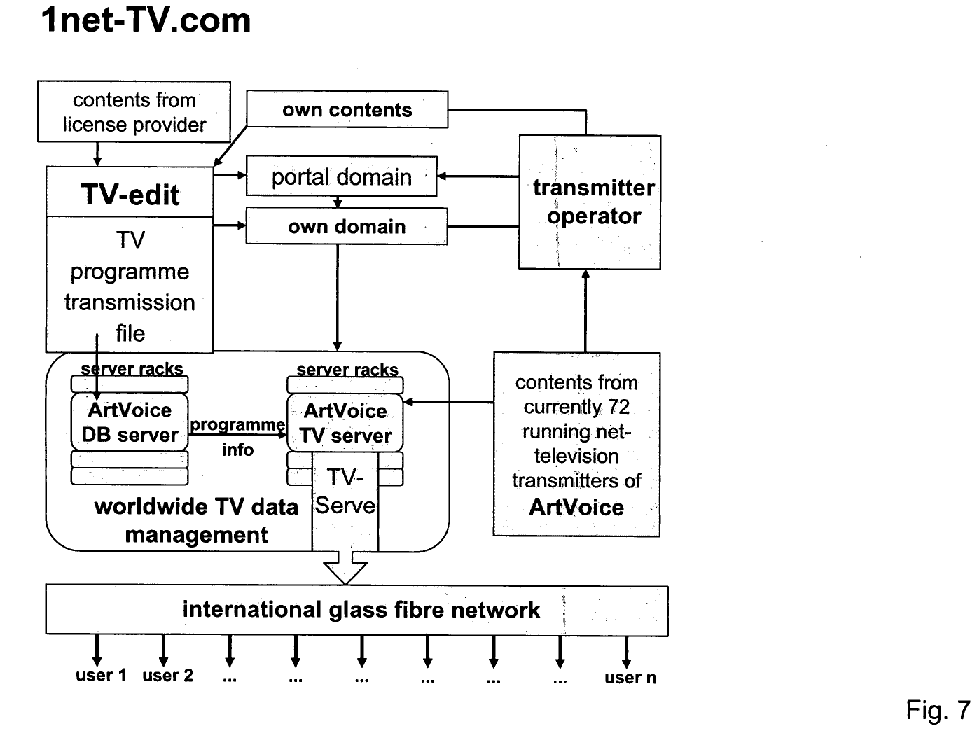

In FIG. 7, a schematic representation of an embodiment “1 net-tv.com” is shown.

This is the process of the television network, as it was described for licence applications (FIG. 4). The difference is that it is also open for private users. Every private user can be both a user, i.e. viewer, and a transmitter operator.

Via the License-Provider application, the user can add external licensed material to the user's own contents. The user's own terminal, mobile telephone, Palm or other devices, as well as the FileLoadBalancing television distribution network, can be used for transmission. The system is useful for the plan of distributing television in a fully decentralized way or only locally on defined Bluetooth or WLAN paths.

Every transmitter operator maintains its own small transmitter user interface on any terminal, and operates its own domain and on it its own TV portal domain. The TV-Edit transmission planning supplies, according to the programme planner's instructions, a TV programme transmission file, which makes it possible to begin, on the transmission servers, on a small scale, the same process for transmission as is carried out in the case of large transmission stations.

The difference with this form of application is the transmission of multiple user transmitters via few transmission servers, which in the case of overload push whole transmitters onto auxiliary server systems.

1-18. (canceled)

19. A method of transmitting a sequence of transmission segments according to a fixed program from multiple transmission servers via packet-oriented distribution paths for viewing by users comprising the step of:
transmitting the transmission segment on all transmission servers.

20. The method according to claim 19 wherein the transmission segment of an individual transmission server of the multiple transmission servers is started and put onto a correct program point only when a first user accesses the transmission segment of the individual transmission server.

21. The method according to claim 19 further comprising storing the transmission segments of the fixed program in a database.

22. The method according to claim 19 wherein the sequence of transmission segments, or their starts of transmission on the transmission servers, differ as a function of features of a user.

23. The method as recited according to claim 22 wherein the features include age, gender, time zone, education, consumer behavior, empirical investigation of the user's program use, interests, or language.

24. The method according to claim 19 wherein one of the distribution paths is a function of the viewer's data line, viewer's IP domain, or ping time to nearest server.

25. The method according to claim 19 wherein distribution of the transmission segments takes place on decentralized sub-databases and/or servers in different IP domains.

26. The method according to claim 25 wherein the distribution of transmission segments taking place on the decentralized sub-databases into a transmission segment sequence is by an expert system and/or a self-learning network.

27. The method according to claim 19 wherein on one transmission server multiple different sequences of transmission segments are transmitted in parallel.

28. The method according to claim 27 wherein individual transmission segments of the multiple different sequences of transmission segments are stored in databases separated from each other.

29. The method according to claim 26 wherein individual transmission segments of the multiple different sequences of transmission segments are held in one database.

30. The method according to claim 26 wherein a same sequence of transmission segments is transmitted in parallel in different transmission bandwidths.

31. The method according to claim 26 wherein a same sequence of transmission segments is transmitted time-shifted in different time zones.

32. The method according to claim 26 wherein the sequence of transmission segments is automatically fixed as a function of a user's profile data.

33. The method according to claim 19 wherein the segments are TV segments.

34. The method according to claim 19 wherein the distribution paths are Internet or IP-based.

35. A method of operating a television station via packet-oriented distribution paths comprising the steps of:
accessing a television network;
accessing a database on which transmission segments are managed depending on loading of associated transmission servers; and
transmitting the transmission segments according to the method of claim 19.

36. The method of operating a television station according to claim 35 wherein the television network is a neural television network putting together transmission segments as a function of viewer habits.

37. The method of operating a television station according to claim 35 wherein an entirety of the database-based transmission system is adapted as a function of viewing habits of a transmitter target group and a transmission capacity of the transmission servers of individual IP-based TV stations.

38. The method of operating a television station according to claim 35 further comprising:
creating of segments which occur as a new program group, and as a new segment automatically influence the licensing; and
finding further segments and implemented film clips and including these in segment groups by automatic editing or insertion into the transmission sequence without generating a new segment.

39. The method of operating a television station according to claim 35 wherein anyone is able to provide transmission segments on the database, the database being decentralized.

40. The method as recited in claim 35 wherein the distribution paths are Internet or EP-based.
